(19) United States
(12) Patent Application Publication
(10) Pub. No.: US 2006/0033696 A1
(43) Pub. Date: Feb. 16, 2006

(54) Gate line driving circuit

(76) Inventors: Tetsuya Nakamura, Moriguchi-shi (JP); Seiji Kawaguchi, Hirakata-shi (JP); Masahiko Takeoka, Yamatokoriyama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/202,338

(22) Filed: Aug. 12, 2005

(30) Foreign Application Priority Data
Aug. 13, 2004 (JP) 2004-235968

(51) Int. Cl. G09G 3/36

(52) U.S. Cl. 345/100

(57) ABSTRACT

A gate line driving circuit includes a shift register section that selects gate lines for gradation display in units of one gate line, and selects the gate lines for black insertion in units of a group including at least two adjacent gate lines, and an output circuit that outputs driving signals to the gate lines selected by the shift register section. In particular, the output circuit is configured such that an output period of a driving signal to an odd-numbered gate line, which is included in the group selected for black insertion by the shift register section and extends along a row of liquid crystal pixels that are capacitive-coupled to a non-selected gate line other than the gate lines of the group, is set to be shorter than an output period of a driving signal to an even-numbered gate line of the group.

### CROSS-REFERENCE TO RELATED APPLICATIONS

This application is based upon and claims the benefit of priority from prior Japanese Patent Application No. 2004-235968, filed Aug. 13, 2004, the entire contents of which are incorporated herein by reference.

### BACKGROUND OF THE INVENTION

1. Field of the Invention

The present invention relates to a gate line driving circuit that is applied, for example, to an OCB (Optically Compensated Birefringence) mode liquid crystal display panel.

2. Description of the Related Art

Flat-panel display devices, which are typified by liquid crystal display devices, have widely been used as display devices for computers, car navigation systems, TV receivers, etc.

The liquid crystal display device generally includes a liquid crystal display panel including a matrix array of liquid crystal pixels, and a display panel control circuit that controls the display panel. The liquid crystal display panel is configured such that a liquid crystal layer is held between an array substrate and a counter substrate.

The array substrate includes a plurality of pixel electrodes that are arrayed substantially in a matrix, a plurality of gate lines that are arranged along rows of the pixel electrodes, a plurality of source lines that are arranged along columns of the pixel electrodes, and a plurality of switching elements that are arranged near intersections between the gate lines and the source lines. Each of the switching elements is formed of, e.g. a thin-film transistor (TFT), and turned on to apply a potential of one source line to one pixel electrode when one gate line is driven. On the counter substrate, a common electrode is provided to face the pixel electrodes arrayed on the array substrate. Each pair of pixel electrode and common electrode is associated with a pixel area of the liquid crystal layer to form a pixel, and controls the alignment state of liquid crystal molecules in the pixel area by an electric field obtained between the electrodes. The display panel control circuit includes a gate driver that drives the gate lines, a source driver that drives the source lines, and a controller that controls operational timings of the gate driver and source driver.

In the case where the liquid crystal display device is used for a TV receiver that principally displays a moving image, a liquid crystal display panel of an OCB mode, in which liquid crystal molecules exhibit good responsivity, is generally employed (see Jpn. Pat. Appln. KOKAI Publication No. 2002-202491). In the liquid crystal display panel, the liquid crystal molecules are aligned in a splay alignment before supply of power. This splay alignment is a state where the liquid crystal molecules are laid down, and obtained by alignment films which are disposed on the pixel electrode and the counter electrode and rubbed in parallel with each other. The liquid crystal display panel performs an initializing process upon supply of power. In this process, a relatively strong electric field is applied to the liquid crystal molecules to transfer the splay alignment to a bend alignment. A display operation is performed after the initializing process.

The reason why the liquid crystal molecules are aligned in the splay alignment before supply of power is that the splay alignment is more stable than the bend alignment in terms of energy in a state where the liquid crystal driving voltage is not applied. As a characteristic of the liquid crystal molecules, the bend alignment tends to be inverse-transferred to the splay alignment if a state where no voltage is applied or a state where a voltage lower than a level at which the energy of splay alignment is balanced with the energy of bend alignment is applied, continues for a long time. The viewing angle characteristic of the splay alignment significantly differs from that of the bend alignment. Thus, a normal display is not attained in this splay alignment.

In a conventional driving method that prevents the inverse transfer from the bend alignment to the splay alignment, a high voltage is applied to the liquid crystal molecules in a part of a frame period for a display of a 1-frame image, for example. This high voltage corresponds to a pixel voltage for a black display in an OCB-mode liquid crystal display panel, which is a normally-white type, so this driving method is called “black insertion driving.” In the meantime, in the black insertion driving, the visibility, which lowers due to retinal persistence occurring on a viewer's vision in a moving image display, is improved by discrete pseudo-impulse response of luminance.

A pixel voltage for black insertion and a pixel voltage for gradation display are applied to all liquid crystal pixels on a row-by-row basis in one frame period, i.e. one vertical scanning period (V). The ratio of a storage period of the pixel voltage for black insertion to a storage period of the pixel voltage for gradation display is a black insertion ratio. In a case where each gate line is driven for black insertion in a half of one horizontal scanning period, i.e. H/2 period, and is driven for gradation display in a subsequent H/2 period, the vertical scanning speed becomes twice higher than in the case where black insertion is not executed. Since the value of the pixel voltage for black insertion is common to all pixels, it is possible to drive, for instance, two gate lines together as a set. In a case where two gate lines of each set are driven together for black insertion in a 2H/3 period, and are sequentially driven for gradation display in a 4H/3 period (2H/3 for each of two gate lines), the vertical scanning speed becomes 1.5 times higher than in the case where black insertion is not executed.

Conventionally, when a plurality of gate lines are driven together for black insertion, a horizontal stripe appear on the display panel. Such a horizontal stripe degrades the display quality.

### BRIEF SUMMARY OF THE INVENTION

The object of the present invention is to provide a gate line driving circuit that is capable of preventing occurrence of a horizontal stripe in black insertion driving for maintaining the bend alignment of liquid crystal molecules.

According to a first aspect of the present invention, there is provided a gate line driving circuit that drives a plurality of gate lines, which are assigned to rows of pixels arrayed substantially in a matrix, the gate line driving circuit comprising: a shift register section that selects the gate lines for gradation display in units of one gate line, and selects the gate lines for non-gradation display in units of a group including at least two adjacent gate lines; and an output circuit that outputs a driving signal to the gate line selected by the shift register section, the output circuit being configured such that an output period of a driving signal to a specified one of the gate lines, which are included in the group selected for non-gradation display by the shift register section and extends along a row of pixels that are capacitive-coupled to a non-selected gate line other than the gate lines of the group, is set to be shorter than output periods of driving signals to the other gate lines of the group.

According to a second aspect of the present invention, there is provided a gate line driving circuit that drives a plurality of gate lines, which are assigned to rows of pixel electrodes arrayed substantially in a matrix and each of which are capacitive-coupled to the pixel electrodes on a non-assigned row, the gate line driving circuit comprising: a selecting section that sequentially selects the gate lines for gradation display in units of one gate line in a vertical scanning period, and sequentially selects the gate lines for non-gradation display in units of at least two adjacent gate lines in a period substantially equal to the vertical scanning period; and an output circuit that outputs a driving signal to the gate line selected by the selecting section, the output circuit being configured such that, in a state where the adjacent gate lines are selected together for non-gradation display, termination timings of driving signals output to the adjacent gate lines are displaced to equalize effects of capacitive-coupling.

With the gate line driving circuits, at least two adjacent gate lines are driven together for non-gradation. Since rows of pixels corresponding to the adjacent gate lines are capacitive-coupled to different gate lines, the effects of capacitive-coupling appear in the pixel voltages stored in the rows of pixels, when the adjacent gate lines are changed from a driving state to a non-driving state. If a difference occurs between the voltages stored in the rows of pixels due to the effects of capacitive-coupling, this leads a difference in luminance that is observed as a horizontal stripe. However, the output circuit displaces the output periods, more specifically, termination timings of the driving signals to the adjacent gate lines to equalize the effects of capacitive-coupling. This minimizes the difference between the pixel voltages stored in the rows of pixels corresponding to the adjacent gate lines, thereby preventing occurrence of a horizontal stripe.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the circuit configuration of a liquid crystal display device according to an embodiment of the present invention;

FIG. 2 shows in detail a gate line driving circuit of a gate driver shown in FIG. 1; and

FIG. 3 is a time chart that illustrates the operation of the gate line driving circuit shown in FIG. 2 in a case where black insertion driving is executed at a 1.5× vertical scanning speed.

### DETAILED DESCRIPTION OF THE INVENTION

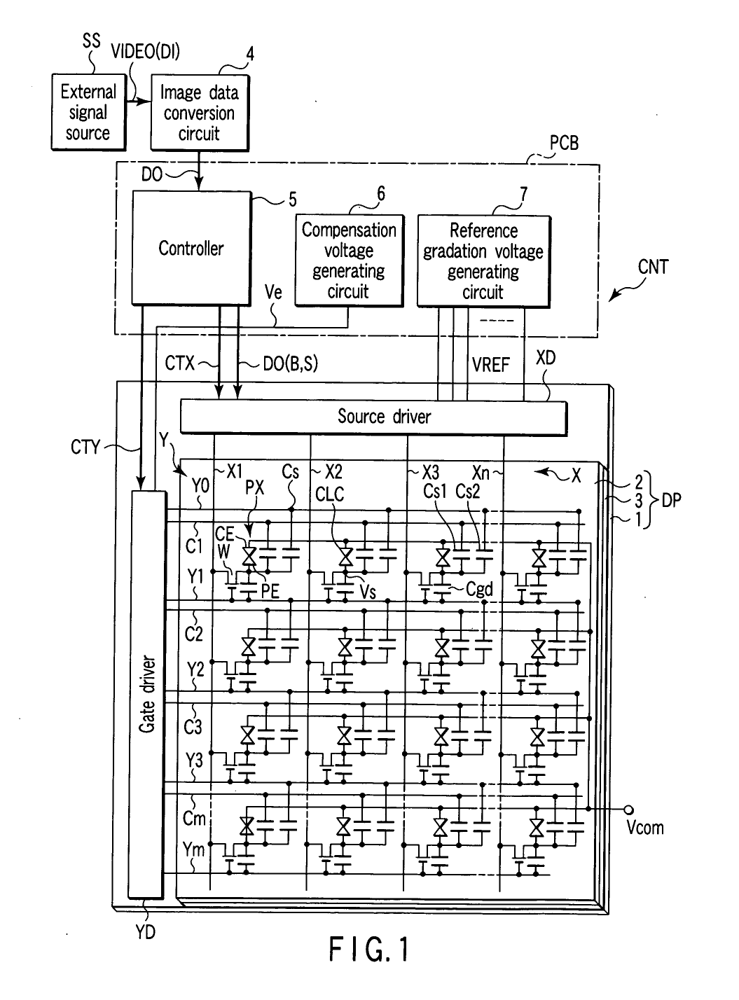

A liquid crystal display device according to an embodiment of the present invention will now be described with reference to the accompanying drawings. FIG. 1 schematically shows the circuit configuration of the liquid crystal display device. The liquid crystal display device comprises a liquid crystal display panel DP and a display panel control circuit CNT that is connected to the display panel DP. The liquid crystal display panel DP is configured such that a liquid crystal layer 3 is held between an array substrate 1 and a counter substrate 2, which are a pair of electrode substrates. The liquid crystal layer 3 contains a liquid crystal material whose liquid crystal molecules are transferred in advance from a splay alignment to a bend alignment usable for a normally-white display, and are prevented from being inverse-transferred from the bend alignment to the splay alignment by a voltage for black insertion (non-gradation display) that is cyclically applied. The display panel control circuit CNT controls the transmittance of the liquid crystal display panel DP by a liquid crystal driving voltage that is applied from the array substrate 1 and counter electrode 2 to the liquid crystal layer 3. The splay alignment is transferred to the bend alignment by a relatively strong electric field applied to the liquid crystal layer 3.

The array substrate 1 includes a plurality of pixel electrodes PE that are arrayed substantially in a matrix on a transparent insulating substrate of, e.g. glass; a plurality of gate lines Y (Y0 to Ym) that are disposed along rows of the pixel electrodes PE; a plurality of storage capacitance lines C (C1 to Cm) that are disposed in parallel to the gate lines Y (Y0 to Ym) along the rows of the pixel electrodes PE; a plurality of source lines X (X1 to Xn) that are disposed along columns of the pixel electrodes PE; and a plurality of pixel switching elements W that are disposed near intersections between the gate lines Y and source lines X, each pixel switching element W being rendered conductive between the associated source line X and associated pixel electrode PE when driven via the associated gate line Y. Each of the pixel switching elements W is composed of, e.g. a thin-film transistor. The thin-film transistor has a gate connected to the associated gate line Y, and a source-drain path connected between the associated source line X and pixel electrode PE.

The counter substrate 2 includes a color filter that is disposed on a transparent insulating substrate of, e.g. glass, and a common electrode CE that is disposed on the color filter so as to be opposed to the pixel electrodes PE. Each pixel electrode PE and the common electrode CE are formed of a transparent electrode material such as ITO, and are coated with alignment films that are subjected to rubbing treatment in directions parallel to each other. To form an OCB liquid crystal pixel PX, each pixel electrode PE and the common electrode CE are associated with a pixel area of the liquid crystal layer 3 which is controlled to have a liquid crystal alignment corresponding to an electric field applied from the pixel electrode PE and common electrode CE.

Each of OCB liquid crystal pixels PX has a liquid crystal capacitance CLC between the associated pixel electrode PE and the common electrode CE. Each of the storage capacitance lines C1 to Cm constitutes storage capacitances Cs1 by capacitive-coupling to the pixel electrodes PE of the liquid crystal pixels on the associated row. In addition, each of the gate lines Y0 to Ym-1 constitutes storage capacitances Cs2 by capacitive-coupling to the pixel electrodes PE of the liquid crystal pixels on the associated row. The sum of the storage capacitances Cs1 and Cs2 has a sufficiently high capacitance value, relative to a parasitic capacitance of the pixel switching element W. FIG. 1 omits depiction of a plurality of dummy pixels that are disposed on the periphery of the matrix array of pixels PX that constitute the display screen. The dummy pixels are wired in the same manner as the pixels PX within the display screen. The dummy pixels are provided in order to make equal the conditions, such as parasitic capacitances, for all the pixels PX within the display screen. The gate line Y0 is a gate line for the dummy pixels.

The display panel control circuit CNT includes a gate driver YD that drives the gate lines Y1 to Ym so as to turn on the switching elements W on a row-by-row basis; a source driver XD that outputs pixel voltages Vs to the source lines X1 to Xn in a time period in which the switching elements W on each row are driven by the associated gate line Y; an image data converting circuit 4 that executes, e.g. 1.5× black inserting conversion for image data included in a video signal VIDEO that is input from an external signal source SS; and a controller 5 that controls, e.g. operation timings of the gate driver YD and source driver XD in association with the conversion result. The pixel voltage Vs is a voltage that is applied to the pixel electrode PE with reference to a common voltage Vcom of the common electrode CE. The polarity of the pixel voltage Vs is reversed, relative to the common voltage Vcom, so as to execute, e.g. 2-line-unit-reversal driving and frame-reversal driving (2H1V reversal driving). The image data is composed of pixel data relating to all liquid crystal pixels PX, and is updated in units of one frame period (vertical scanning period V). In the 1.5× black inserting conversion, input pixel data DI for two rows are converted in every 2H period to pixel data B for black insertion (non-gradation display) for one row and pixel data S for gradation display for two rows, which become output pixel data DO. The pixel data S for gradation display has the same gradation value as the pixel data DI, and the pixel data B for black insertion has a gradation value for black display. Each of the pixel data B for black insertion for one row and the pixel data S for gradation display for two rows is serially output from the image data converting circuit 4 in every 2H/3 period.

The gate driver YD and source driver XD are constructed using thin-film transistors that are formed in the same fabrication steps as, e.g. the switching elements W. On the other hand, the controller 5 is disposed on an outside printed circuit board PCB. The image data converting circuit 4 is disposed further on the outside of the printed circuit board PCB. The controller 5 generates a control signal CTY for selectively driving the gate lines Y, and a control signal CTX that assigns the pixel data for black insertion or gradation display, which are serially output as a conversion result of the image data converting circuit 4, to the source lines X, and designates the signal polarity. The control signal CTY is supplied from the controller 5 to the gate driver YD. The control signal CTX is supplied from the controller 5 to the source driver XD, together with the pixel data DO that is the pixel data B for black insertion or the pixel data S for gradation display, which is obtained as a conversion result of the image data converting circuit 4.

The display panel control circuit CNT further includes a compensation voltage generating circuit 6 and a reference gradation voltage generating circuit 7. The compensation voltage generating circuit 6 generates a compensation voltage Ve that is applied via the gate driver YD to the storage capacitance line C of the row corresponding to switching elements W on one row when the switching elements W on this row are turned off, and that compensates a variation in the pixel voltage Vs, which occurs in the pixels PX on the associated row due to parasitic capacitances of these switching elements W. The reference gradation voltage generating circuit 7 generates a predetermined number of reference gradation voltages VREF that are used in order to convert the pixel data DO to the pixel voltage Vs.

Under the control of the control signal CTY, the gate driver YD selects the gate line, Y1 to Ym, for black insertion in every vertical scanning period, and delivers to the selected gate line Y a driving signal so as to turn on the pixel switching elements W on each row in every 2H/3 period. Further, the gate driver YD selects the gate line, Y1 to Ym, for gradation display in every vertical scanning period, and delivers to the selected gate line Y a driving signal so as to turn on the pixel switching elements W on each row in every 2H/3 period. The image data converting circuit 4 sequentially outputs the pixel data B for black insertion for one row and the pixel data S for gradation display for two rows, which are obtained as the output pixel data DO that are the result of conversion. The source driver XD refers to the predetermined number of reference gradation voltages VREF, which are delivered from the reference gradation voltage generating circuit 7, and converts the pixel data B for black insertion and the pixel data S for gradation display to the pixel voltages Vs and outputs the pixel voltages Vs to the source lines X1 to Xn in parallel.

Assume now that the gate driver YD drives the gate line Y1, for instance, by the driving voltage, and turns on all pixel switching elements W that are connected to the gate line Y1. In this case, the pixel voltages on the source lines X1 to Xn are applied via the pixel switching elements W to the associated pixel electrodes PE and to terminals at one end of the associated storage capacitances Cs1, Cs2. In addition, the gate driver YD outputs the compensation voltage Ve from the compensation voltage generating circuit 6 to the storage capacitance line C1 that corresponds to the other terminals of the associated storage capacitances Cs1. Immediately after turning on all pixel switching elements W, which are connected to the gate line Y1, for a 2H/3 period, the gate driver YD outputs to the gate line Y1 a non-driving voltage that turns off the pixel switching elements W. When the pixel switching elements W are turned off, the compensation voltage Ve reduces the amount of charge that leaks from the pixel electrodes PE to charge the parasitic capacitances of the pixel switching elements W, thereby substantially canceling a variation in pixel voltage Vs, that is, a field-through voltage ΔVp.

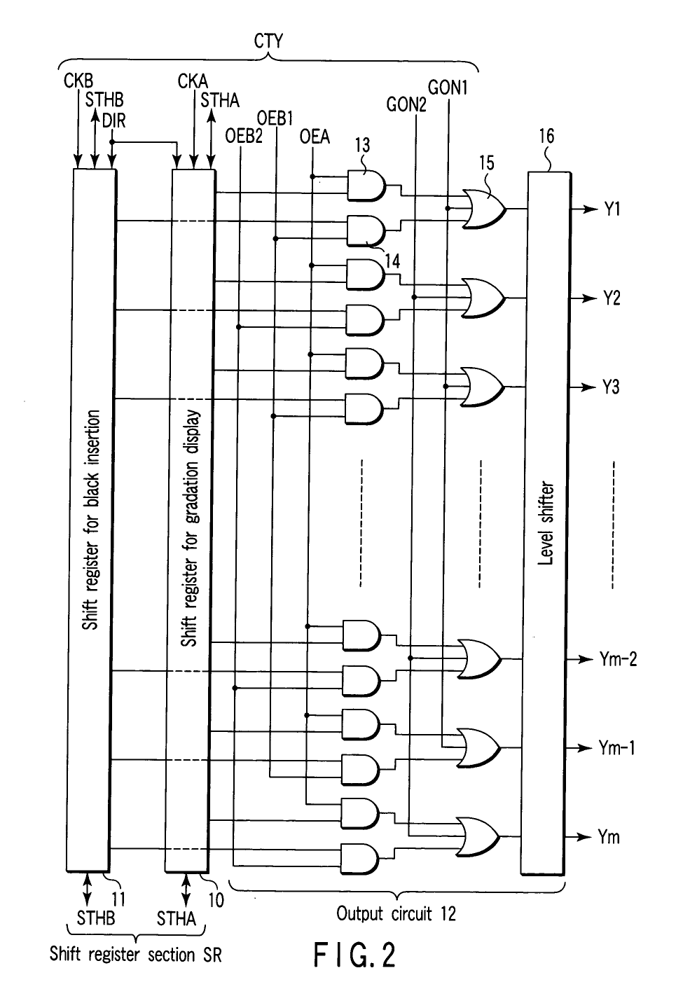

FIG. 2 shows in detail the gate line driving circuit of the gate driver YD. The gate line driving circuit includes a shift register section SR that selects gate lines Y1 to Ym for gradation display and black insertion, and an output circuit 12 that outputs a driving signal to the gate line selected for gradation display and black insertion by the shift register section SR.

Specifically, the shift register section SR comprises a shift register 10 for gradation display (a first shift register), which shifts a first start signal STHA in response to a first clock signal CKA, and a shift register 11 for black insertion (a second shift register), which shifts a second start signal STHB in response to a second clock signal CKB synchronous with the first clock signal CKA. The output circuit 12 is configured to output a driving signal, under control of a first output enable signal OEA, to the gate line Y that is selected in accordance with the shift position of the first start signal STHA stored in the shift register 10 for gradation display, and a driving signal, under control of one of a second output enable signal OEB1 and a third output enable signal OEB2, to the gate line Y that is selected in accordance with the shift position of the second start signal STHB stored in the shift register 11 for black insertion. The gate lines Y1 to Ym are divided into a first gate line group including odd-numbered gate lines Y1, Y3, Y5, . . . , and a second gate line group including even-numbered gate lines Y2, Y4, Y6, . . . . The first and second groups are alternately selected by a first group selection signal GON1 and a second group selection signal GON2 in an initializing process for all the OCB liquid crystal pixels PX. The first group selection signal GON1, second group selection signal GON2, first clock signal CKA, first start signal STHA, second clock signal CKB, second start signal STHB, first output enable signal OEA, second output enable signal OEB1 and third output enable signal OEB2 are all included in the control signal CTY that is supplied from the controller 5.

Each of the shift register 10 for gradation display and the shift register 11 for black insertion comprises series-connected m-stages of registers that are assigned to the gate lines Y1 to Ym. The first start signal STHA and second start signal STHB are input to the first-stage registers that are assigned to the gate line Y1. In the shift register 10 for gradation display, the first start signal STHA is shifted from the first-stage register toward the m-th stage register. In the shift register 11 for black insertion, the second start signal STHB is shifted from the first-stage register toward the m-th stage register. Each of all registers in the shift register 10 for gradation display has an output terminal that outputs a selection signal for the associated gate line Y, which rises to a high level while the first start signal STHA is being retained. Each of all registers in the shift register 11 for black insertion has an output terminal that outputs a selection signal for the associated gate line Y, which rises to a high level while the second start signal STHB is being retained.

The output circuit 12 includes an m-number of AND gate circuits 13, an m-number of AND gate circuits 14, an m-number of OR gate circuits 15 and a level shifter 16. The m-number of AND gate circuits 13 are so connected as to output the selection signals for the gate lines Y1 to Ym, which are obtained from the shift register 10 for gradation display, to the m-number of OR gate circuits 15 under the control of the first output enable signal OEA. The first output enable signal OEA permits all the AND gate circuits 13 to output the selection signals in the state in which the first output enable signal OEA is set at a high level, and the first output enable signal OEA prohibits all the AND gate circuits 13 from outputting the selection signals in the state in which the first output enable signal OEA is set at a low level. The m-number of AND gate circuits 14 are so connected as to output the selection signals for the gate lines Y1 to Ym, which are obtained from the shift register 11 for black insertion, to the m-number of OR gate circuits 15 under the control of one of the second output enable signal OEB1 and third output enable signal OEB2. The second output enable signal OEB1 permits all odd-numbered AND gate circuits 14 to output the selection signals in the state in which the second output enable signal OEB1 is set at a high level, and the second output enable signal OEB1 prohibits all odd-numbered AND gate circuits 14 from outputting the selection signals in the state in which the second output enable signal OEB1 is set at a low level. The third output enable signal OEB2 permits all even-numbered AND gate circuits 14 to output the selection signals in the state in which the third output enable signal OEB2 is set at a high level, and the third output enable signal OEB2 prohibits all even-numbered AND gate circuits 14 from outputting the selection signals in the state in which the third output enable signal OEB2 is set at a low level. The duration of each of the first and third output enable signals OEA and OEB2 is set at 2H/3, and the duration of the second output enable signal OEB1 is set to be less than the duration of the third output enable signal OEB2 by a predetermined period ΔT of about 2 μs. The m-number of OR gate circuits 15 input the selection signals from the associated AND gate circuits 13 and the selection signals from the associated AND gate circuits 14 to the level shifter 16. Half of the m-number of OR gate circuits 15 are used for odd-numbered gate lines, and input the first group selection signal GON1 to the level shifter 16 as the selection signal for the odd-numbered gate line, Y1, Y3, Y5, . . . . The other half of the OR gate circuits 15 are used for even-numbered gate lines, and input the second group selection signal GON2 to the level shifter 16 as the selection signal for the even-numbered gate line, Y2, Y4, Y6, . . . . The level shifter 16 is configured to shift the level of the voltages of the selection signals that are input from the m-number of OR gate circuits 15, thereby converting the voltages to driving signals for turning on the thin-film transistors W, and delivering the driving signals to the gate lines Y1 to Ym.

The shift register 10 for gradation display and the shift register 11 for black insertion can shift the first start signal STHA and second start signal STHB not only in a downward direction from the first-stage register toward the m-th stage register, but also in an upward direction from the m-th stage register toward the first-stage register. The directions of shift of the first start signal STHA and second start signal STHB are changed by a scan direction signal DIR that is supplied from the controller 5 to the shift register 10, 11.

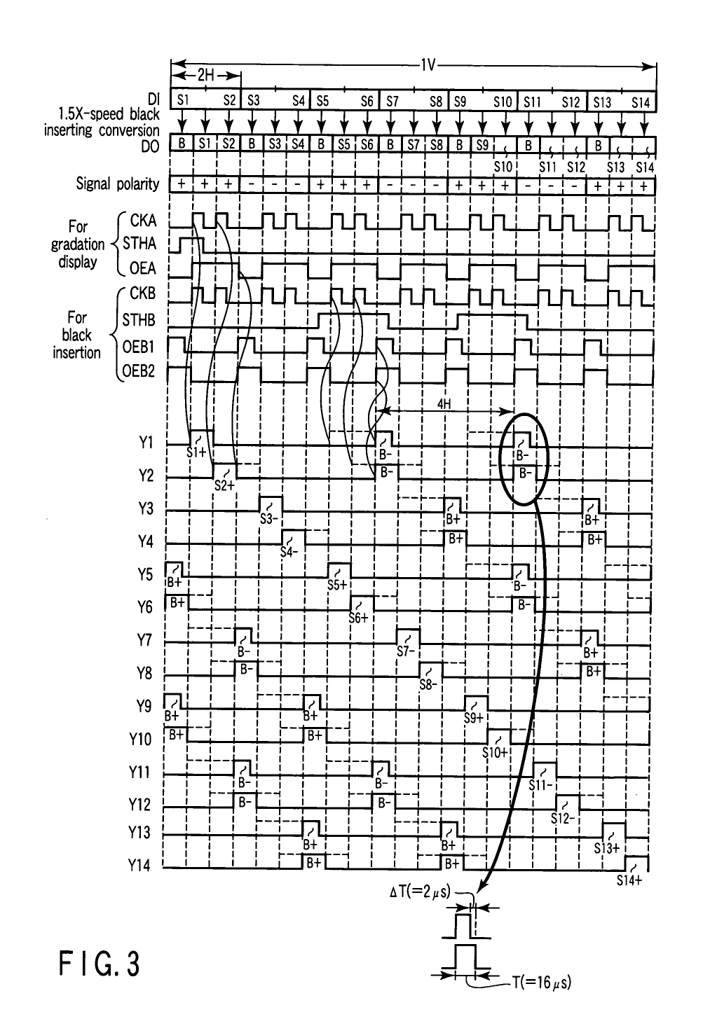

FIG. 3 illustrates the operation of the gate line driving circuit in a case where black insertion driving is executed at a 1.5× vertical scanning speed. In FIG. 3, symbol B represents pixel data for black insertion, which is common to the pixels PX of the respective rows, and S1, S2, S3, . . . , designate pixel data for gradation display, which are associated with pixels PX on the first row, pixels PX on the second row, pixels PX on the third row, etc. Symbols + and − represent signal polarities at a time when the pixel data B, S1, S2, S3, . . . , are converted to pixel voltages Vs and output from the source driver XD.

The first start signal STHA is a pulse that is input to the shift register 10 for gradation display with a pulse width corresponding to a 2H/3 period. The first clock signal CKA is a 2H/3-cycle pulse that is input to the shift register 10 for gradation display at a rate of 2 pulses per 2H period. The shift register 10 for gradation display shifts the first start signal STHA in response to the first clock signal CKA, and outputs the selection signals to sequentially select the gate lines Y1 to Ym in a manner that each line remains selected for a 2H/3 period. In this scheme, the pulse of the first clock signal CKA is omitted in the first 2H/3 period in the 2H period. Thus, the selection signal for an even-numbered gate line Y2, Y4, Y6, . . . , is continuously output until the end of the first 2H/3 period in the subsequent 2H period. On the other hand, the m-number of AND gate circuits 13 output, under the control of the first output enable signal OEA, the selection signals, which are sequentially obtained from the shift register 10 for gradation display, to the m-number of OR gate circuits 15 in the second and third 2H/3 periods in the associated 2H period. Each selection signal is supplied from the associated OR gate circuit 15 to the level shifter 16. The level shifter 16 converts the selection signal to a driving signal and outputs it to the associated gate line Y. Besides, the source driver XD converts each of the pixel data for gradation display, S1, S2, S3, . . . , to the pixel voltages Vs in the second and third 2H/3 periods in the associated 2H period, and outputs the pixel voltages Vs in parallel to the source lines X1 to Xn with the polarity that is reversed in every 2H period. The pixel voltages Vs are applied to the liquid crystal pixels PX on the first row, second row, third row, . . . , while each of the gate lines Y1 to Ym is driven in the second and third 2H/3 periods in the associated 2H period.

On the other hand, the second start signal STHB is a pulse that is input to the shift register 11 for black insertion with a pulse width corresponding to a 2H period. The second clock signal CKB is a 2H/3-cycle pulse that is input to the shift register 11 for black insertion at a rate of 2 pulses per 2H period in sync with the first clock signal CKA. The shift register 11 for black insertion shifts the second start signal STHB in response to the second clock signal CKB, and outputs the selection signals to sequentially select the gate lines Y1 to Ym in units of two lines. The m-number of AND gate circuits 14 output, under the control of one of the second and third output enable signals OEB1 and OEB2, the selection signals, which are sequentially obtained from the shift register 11 for black insertion, to the m-number of OR gate circuits 15 in the first 2H/3 period in the subsequent 2H period. Each selection signal is supplied from the associated OR gate circuit 15 to the level shifter 16. The level shifter 16 converts the selection signal to a driving signal and outputs it to the associated gate line Y. On the other hand, the source driver XD converts each of the pixel data for black insertion, B, B, B, . . . , to the pixel voltages Vs in the first 2H/3 period of the associated 2H period, and outputs the pixel voltages Vs in parallel to the source lines X1 to Xn with the polarity that is reversed in every 2H period. The pixel voltages Vs are applied to the liquid crystal pixels PX on the first & second rows, third & fourth rows, fifth & sixth rows, . . . , while each of the gate lines Y1 to Ym is driven in the first 2H/3 period in the associated 2H period. In FIG. 3, the first start signal STHA and second start signal STHB are input with a relatively short interval. Actually, the first start signal STHA and second start signal STHB are input with a relatively long interval so that the ratio of a voltage storage period for black insertion to a voltage storage period for gradation display may accord with a black insertion ratio. In addition, it is preferable to input the second start signal STHB once again with a delay of 4H after the first input of the second start signal STHB. Thereby, each gate line Y is driven twice for black insertion. Accordingly, even in the case where it is difficult to shift the potential of the associated pixel electrode PE up to a high pixel voltage Vs for black insertion within a short period of 2H/3, the pixel voltage Vs can surely be set in the pixel electrode PE. The above-mentioned 4H delay is needed in order to uniformize the polarity of the pixel voltages Vs for black insertion. In the meantime, black insertion for the pixels PX near the last row is continuous from the preceding frame, for example, as shown in the lower left part of FIG. 3.

The process for initializing all OCB liquid crystal pixels PX is executed before and after the above-described operation. In the initializing process, for example, the first group selection signal GON1 and second group selection signal GON2 are alternately input once. If the first group selection signal GON1 is first input to each of the OR gate circuits 15 for odd-numbered gate lines, the first group selection signal GON1 is delivered to the level shifter 16 as the selection signal for each associated odd-numbered gate line Y. The level shifter 16 converts the selection signals to driving signals and output them to the associated odd-numbered gate lines Y. Thereby, all the odd-numbered gate lines Y1, Y3, Y5, . . . , are driven. During this time, the source driver XD converts pixel data for initialization to pixel voltages Vs, whose values are substantially equal to the value for white display, and outputs the pixel voltages Vs in parallel to all source lines X1 to Xn. At this time, the common voltage Vcom on the common electrode CE side is set so as to obtain a liquid crystal driving voltage, which is necessary for transfer from the splay alignment to bend alignment, as a difference between the common voltage Vcom and the pixel voltage Vs. In this manner, the OCB liquid crystal pixels PX on the odd-numbered rows are initialized in the uniform bend alignment.

Subsequently, if the second group selection signal GON2 is input to each of the OR gate circuits 15 for even-numbered gate lines, the second group selection signal GON2 is delivered to the level shifter 16 as the selection signal for each associated even-numbered gate line Y. The level shifter 16 converts the selection signals to driving signals and output them to the associated even-numbered gate lines Y. Thereby, all the even-numbered gate lines Y2, Y4, Y6, . . . , are driven. During this time, the source driver XD converts pixel data for initialization to pixel voltages Vs, whose values are substantially equal to the value for white display, and outputs the pixel voltages Vs in parallel to all source lines X1 to Xn. At this time, the common voltage Vcom on the common electrode CE side is set so as to obtain a liquid crystal driving voltage, which is necessary for transition from the splay alignment to bend alignment, as a difference between the common voltage Vcom and the pixel voltage Vs. In this manner, the OCB liquid crystal pixels PX on the even-numbered rows are initialized in the uniform bend alignment.

In the present embodiment, the gate lines Y1 to Ym are selected for black insertion in units of a group including two adjacent gate lines Y. In this case, the m-number of second AND gate circuits 14 comprise an m/2 number of AND gate circuits that are assigned to the associated odd-numbered gate lines Y1, 3, 5, . . . , and are controlled by the second output enable signal OEB1, and an m/2 number of AND gate circuits that are assigned to the associated even-numbered gate lines Y2, 4, 6, . . . , and are controlled by the third output enable signal OEB2. The duration of each of the first and third output enable signals OEA and OEB2 is set at 2H/3, and the duration of the second output enable signal OEB1 is set to be less than the duration T of the third output enable signal OEB2 by a predetermined period ΔT. For example, attention will now be paid to a case in which gate lines Y1 and Y2 are selected together for black insertion. The liquid crystal pixels PX on the first row corresponding to the gate line Y1 are capacitive-coupled to the gate line Y0 that is in a non-driving state, and the liquid crystal pixels PX on the second row corresponding to the gate line Y2 are capacitive-coupled to the gate line Y1 that is in a driving state. If the switching elements W that are connected to the liquid crystal pixels PX on the first and second rows are simultaneously rendered non-conductive, the second-row pixels PX corresponding to the gate line Y receive a field-through voltage from the gate line Y2 via parasitic capacitances Cgd of the switching elements W that are connected to the gate line Y2, and also receive, at the same time, a field-through voltage from the gate line Y1 via storage capacitances Cs2 that are connected to the gate line Y1. As a result, the storage potential for black insertion of the first-row liquid crystal pixels PX corresponding to the gate line Y1 becomes different from the storage potential for black insertion of the second-row liquid crystal pixels PX corresponding to the gate line Y2, and such a difference is observed as a horizontal stripe. In this embodiment, however, the output period of the driving signal to the gate line Y1 is made shorter than the output period of the driving signal to the gate line Y2 under the control of the second output enable signal OEB1 and third output enable signal OEB2, thereby preventing the switching elements W for the first-row liquid crystal pixels PX from being rendered non-conductive at the same time as the switching elements W for the second-row liquid crystal pixels PX. Therefore, the second-row liquid crystal pixels PX can be prevented from being affected by the gate line Y1, and the difference in voltage between the first-row liquid crystal pixels PX and the second-row liquid crystal pixels PX can be minimized. Thus, the occurrence of horizontal stripes can be prevented.

The present invention is not limited to the above-described embodiment, and various modifications can be made without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gate line driving circuit that drives a plurality of gate lines, which are assigned to rows of pixels arrayed substantially in a matrix, said gate line driving circuit comprising:
a shift register section that selects the gate lines for gradation display in units of one gate line, and selects the gate lines for non-gradation display in units of a group including at least two adjacent gate lines; and
an output circuit that outputs a driving signal to the gate line selected by the shift register section, said output circuit being configured such that an output period of a driving signal to a specified one of the gate lines, which are included in the group selected for non-gradation display by said shift register section and extends along a row of pixels that are capacitive-coupled to a non-selected gate line other than the gate lines of the group, is set to be shorter than output periods of driving signals to the other gate lines of the group.

2. The gate line driving circuit according to claim 1, wherein said shift register section includes a first shift register which shifts a first start signal for gradation display in response to a first clock signal, and a second shift register which shifts a second start signal for non-gradation display in response to a second clock signal synchronous with the first clock signal,
said output circuit is configured to output, under control of a first output enable signal, a driving signal to the gate line selected by said first shift register, to output, under control of a second output enable signal, a driving signal to the specified gate line selected by said second shift register, and to output, under control of a third output enable signal,
a driving signal to the other gate line selected by said second shift register, and a duration of the second output enable signal is set to be shorter than a duration of the third output enable signal.

3. The gate line driving circuit according to claim 2, wherein said output circuit includes:
a plurality of first AND gate circuits, each of which outputs, under control of the first output enable signal, a selection signal for the associated gate line, which is obtained for gradation display from said first shift register;
a plurality of second AND gate circuits, each of which outputs, under control of one of the second and third output enable signals, a selection signal for the associated gate line, which is obtained for non-gradation display from said second shift register;
a plurality of OR gate circuits, each of which outputs the selection signal for the associated gate line, which is input from one of said first AND gate circuits and one of said second AND gate circuits; and
a level shifter that shifts a level of the selection signal output from each of said OR gate circuits such that the selection signal is converted to the driving signal.

4. The gate line driving circuit according to claim 3, wherein in a case where said gate lines are selected for non-gradation display in units of a group including two adjacent gate lines, said second AND gate circuits comprise a plurality of AND gate circuits that are assigned to the associated odd-numbered gate lines and are controlled by the second output enable signal, and a plurality of AND gate circuits that are assigned to the associated even-numbered gate lines and are controlled by the third output enable signal.

5. A gate line driving circuit that drives a plurality of gate lines, which are assigned to rows of pixel electrodes arrayed substantially in a matrix and each of which are capacitive-coupled to the pixel electrodes on a non-assigned row, said gate line driving circuit comprising:
a selecting section that sequentially selects the gate lines for gradation display in units of one gate line in a vertical scanning period, and sequentially selects the gate lines for non-gradation display in units of at least two adjacent gate lines in a period substantially equal to the vertical scanning period; and
an output circuit that outputs a driving signal to the gate line selected by said selecting section, said output circuit being configured such that, in a state where the adjacent gate lines are selected together for non-gradation display, termination timings of driving signals output to the adjacent gate lines are displaced to equalize effects of capacitive-coupling.
